(19) United States
(12) Patent Application Publication
(10) Pub. No.: US 2018/0349137 A1
(43) Pub. Date: Dec. 6, 2018

(54) RECONFIGURING A PROCESSOR WITHOUT A SYSTEM RESET

(71) Applicant: Intel Corporation, Santa Clara, CA (US)

(72) Inventors: Bharat S. Pillilli, El Dorado Hills, CA (US); Eswaramoorthi Nallusamy, Cedar Park, TX (US); Mahesh S. Natu, Folsom, CA (US)

(21) Appl. No.: 15/613,519

(22) Filed: Jun. 5, 2017

(51) Int. Cl. G06F 9/30; G06F 9/44

(52) U.S. Cl. CPC G06F 9/30043; G06F 9/4418; G06F 9/4405; G06F 9/4403

(57) ABSTRACT

Embodiments of processors, methods, and systems for reconfiguring a processor without a system reset are described. In an embodiment, a processor includes configuration storage, shadow configuration storage, trigger storage, and a trigger circuit. The trigger circuit is to cause, based on trigger storage content, shadow configuration storage content to be copied to the configuration storage.

### FIELD OF INVENTION

The field of invention relates generally to computer architecture, and, more specifically, to multiprocessor systems.

### BACKGROUND

Generally, systems including multiple processors and/or other resources may be configured in a variety of ways. For example, basic input/output system (BIOS) or other system level code may configure a system and the processors within the system differently based on different capabilities provided by and desired from any numbers and/or types of processors, processor cores, memory channels, input/output (I/O) devices, interconnect ports and/or topologies, workload preferences, and other resources in the system. Typically, any such configuration and/or reconfiguration of the system and the processors includes a reset of the system to provide for no transactions between components to be in progress while configuration settings are being changed.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a processor according to an embodiment of the invention;

FIG. 2 is a block diagram illustrating a system according to an embodiment of the invention;

FIG. 3 is a flow diagram illustrating a method for reconfiguring a processor according to an embodiment of the invention;

FIGS. 4 and 5 are block diagrams illustrating systems according to embodiments of the invention;

FIG. 6A is a block diagram illustrating both an exemplary in-order pipeline and an exemplary register renaming, out-of-order issue/execution pipeline according to embodiments of the invention;

FIG. 6B is a block diagram illustrating both an exemplary embodiment of an in-order architecture core and an exemplary register renaming, out-of-order issue/execution architecture core to be included in a processor according to embodiments of the invention;

FIG. 7 is a block diagram of a processor that may have more than one core, may have an integrated memory controller, and may have integrated graphics according to embodiments of the invention;

FIG. 8 is a block diagram of a system in accordance with one embodiment of the present invention;

FIG. 9 is a block diagram of a first more specific exemplary system in accordance with an embodiment of the present invention;

FIG. 10 is a block diagram of a second more specific exemplary system in accordance with an embodiment of the present invention; and

FIG. 11 is a block diagram of a SoC in accordance with an embodiment of the present invention.

### DETAILED DESCRIPTION

In the following description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

References to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type or content of a storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the present invention, a character between terms may mean that an embodiment may include or be implemented using, with, and/or according to the first term and/or the second term (and/or any other additional terms).

When a system includes multiple processors and/or other resources, various configurations may be desired at various times. The use of embodiments of the invention may be desired to provide for reconfiguring processors within the system without a system reset, since resetting the system may take significantly more time than reconfiguring one or more processors without resetting the system. The use of embodiments of the invention may be desired to provide for a variety of system states for power management and/or other reasons, wherein one or more processors and/or portions thereof may be reset and/or reconfigured, in connection with cycling through states, without a system reset, thus improving performance. The use of embodiments of the invention may provide for dynamic system reconfigurability which may provide for better reliability, availability, and serviceability.

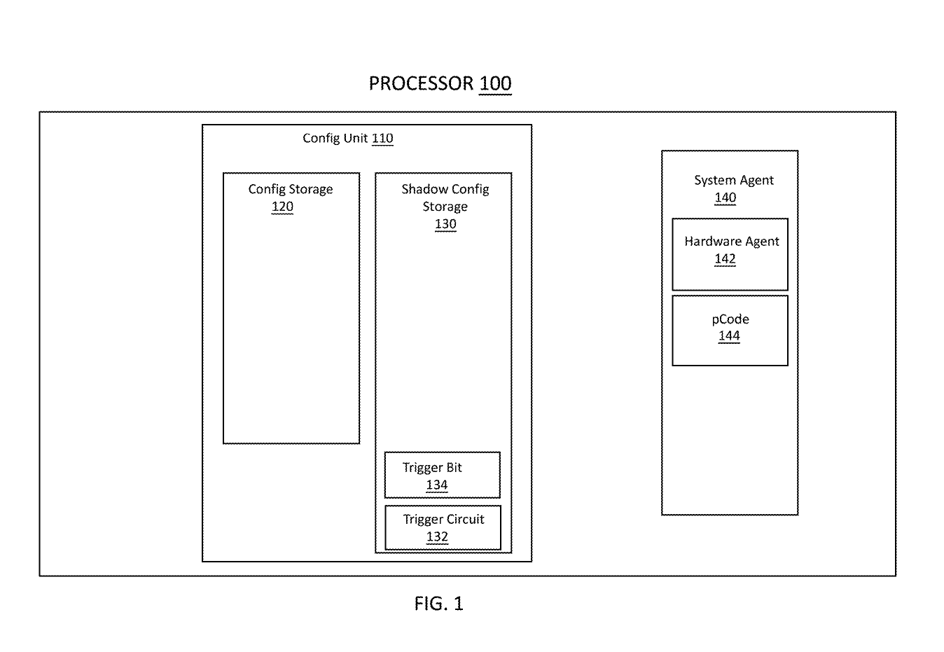

FIG. 1 is a block diagram illustrating a processor according to an embodiment of the invention. Processor 100 may represent all or part of a hardware component including multiple processor or execution cores integrated on a single substrate and/or packaged within a single package. Processor 100 may be any type of processor, including a general purpose microprocessor, such as a processor in the Intel® Core® Processor Family or other processor family from Intel® Corporation or another company, a special purpose processor or microcontroller, or any other device or component in an information processing system in which an embodiment of the present invention may be implemented. Processor 100 may be architected and designed to operate according to any instruction set architecture (ISA), with or without microcode. Processor 100 may represent a processor in any system embodiment of the invention. For example, processor 100 may be represent nay of processors 700, 810, 970, 980, or 1110, each as described below.

Processor 100 is shown including configuration unit 110 and system agent 140. Configuration unit 110 includes configuration storage 120 and configuration shadow storage 130. Configuration storage 120 may represent any number of configuration registers and/or other storage locations, the content of which may be configured and/or programmed by firmware and/or software and may be used to configure any configurable capabilities and/or features of processor 100. Configuration shadow storage 130 may represent any number of configuration registers and/or other storage locations, the content of which may be configured and/or programmed by firmware and/or software and in embodiments, may include a register and/or other storage locations and/or bits and/or fields of such registers and/or storage locations corresponding to each register and/or other storage locations and/or bits and/or fields of such registers and/or storage locations within configuration storage 120.

Configuration shadow storage 130 may include trigger circuit 132 and trigger bit 134. Trigger circuit 132 may represent any circuitry or other hardware to copy the content of configuration shadow storage 130 to configuration storage 120 in response a trigger, as further described below. In an embodiment, the trigger may be the setting of trigger bit 134 and/or the detection by trigger circuit 132 that trigger bit 134 is set. Although shown as single elements in FIG. 1, portions of each of configuration storage 120, configuration storage 130, and configuration trigger circuit 132 may be separated and/or distributed within processor 100 according to any desired approach.

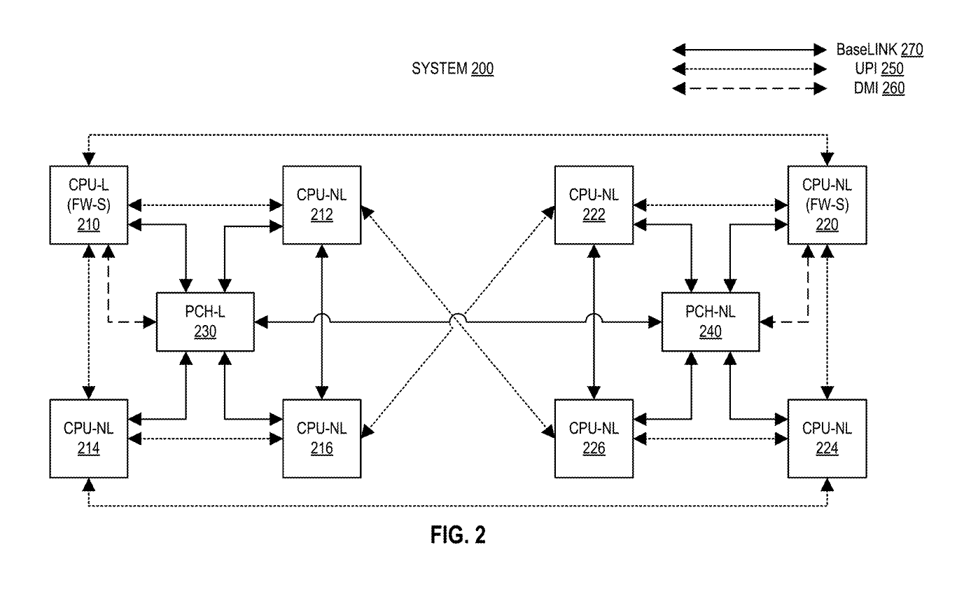

System agent 140 may represent a system agent, uncore, or other portion of processor 100 that is not part of a core (for convenience, any of which may be called a system agent) and/or that includes a microcontroller, micro-engine, or other hardware agent 142 to execute firmware (pCode) 144 within processor 100 without generating any transactions or other activity on a processor interconnect external to processor 100, such as first interconnect 250 in FIG. 2, or on a system interconnect external to processor 100, such as second interconnect 260 in FIG. 2. However, execution of firmware 144 may result in messages being sent between a processor and a PCH (as defined and described below), such as PCH 230 and/or 240, over a sideband link or interconnect, such as third interconnect 260 in FIG. 2.

FIG. 2 is a block diagram illustrating a system according to an embodiment of the invention. System 200 may represent any type of information processing system or platform, such as a server, a desktop computer, a portable computer, a set-top box, a hand-held device such as a tablet or a smart phone, or an embedded control system. System 200 includes processors 210, 212, 214, 216, 220, 222, 224, and 226, and platform controller hubs (PCHs) 230 and 240. Each or any of processors 210, 212, 214, 216, 220, 222, 224, and/or 226 may represent a processor as represented by processor 100 in FIG. 1. Each of PCHs 230 and 240 may represent a component through which any one or more processors may be connected to any one or more I/O devices or other components, including other processors and/or PCHs. A PCH may include circuitry and/or logic to perform any of the functions of a chipset in a computer system.

Systems and/or platforms embodying the invention may include any number of processors, PCHs, and any other components or other elements, such as peripherals and/or I/O devices. Any or all of the components or other elements in this or any system embodiment may be connected, coupled, or otherwise in communication with each other through any number of buses, point-to-point, or other wired or wireless interfaces or connections, unless specified otherwise. Any components or other portions of system 200, whether shown in FIG. 2 or not shown in FIG. 2, may be integrated or otherwise included on or in a single chip (a system-on-a-chip or SOC), die, substrate, or package.

In system 200, each processor may be connected to each other processor through a first interconnect 250, such as UltraPath Interconnect (UPI), QuickPath Interconnect (QPI), HyperTransport, or any other point-to-point or other processor bus or interconnect. One of the processors, such as processor 210, may be designated as a legacy processor (CPU-L) while the others are designated as non-legacy processors (CPU-NL). The legacy processor may be connected, through a second interconnect 260, such as Direct Media Interconnect (DMI), Peripheral Component Interconnect Express (PCIe), or any other system bus or interconnect. to a PCH, such as PCH 230, thus, that PCH may be referred to as a legacy PCH (PCH-L). One of the non-legacy processors, such as processor 220, may be connected to another PCH, such as PCH 240, thus, that PCH may be referred to as a non-legacy PCH. Processors connected to second interconnect 260 may also be referred to as firmware agents (FW-S), since they also act as an interface for other processors to reach firmware storage, such as Serial Peripheral Interface (SPI) flash memory, through a PCH. In addition, each processor may be connected to a PCH through a third interconnect 270, such as a three-wire, bi-directional, low-speed, low-bandwidth link or any other bus or interconnect through which a processor and a PCH may communicate messages according to embodiments of the invention. PCHs, such as PCH 230 and PCH 240, may also be connected to each other through third interconnect 270.

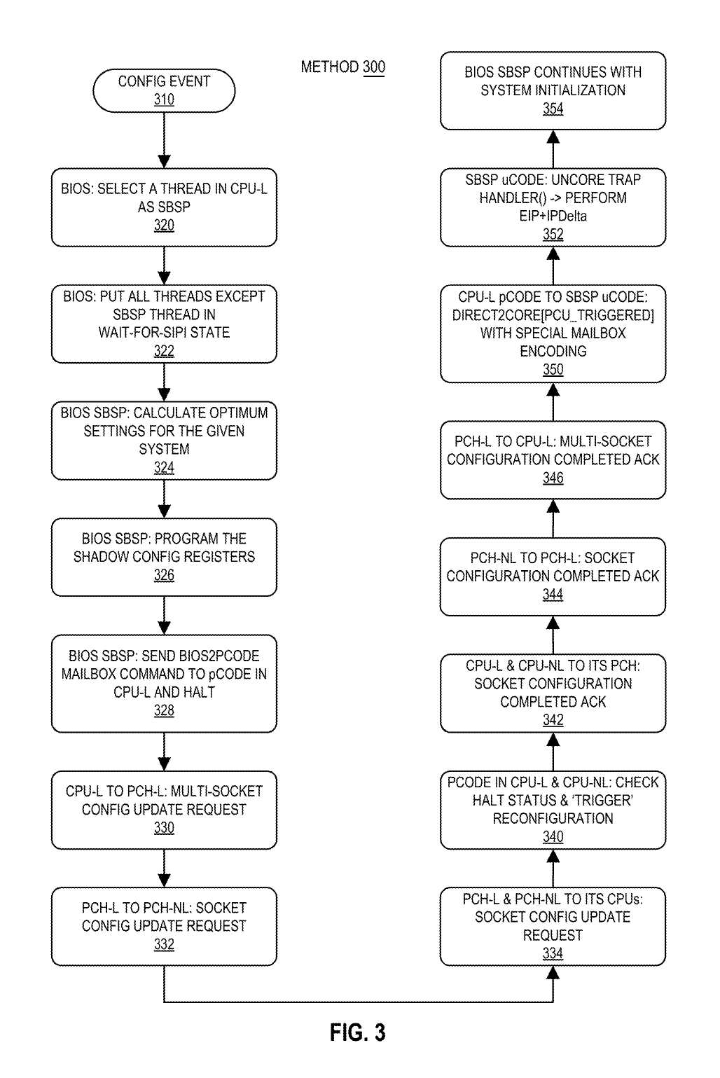

FIG. 3 is a flow diagram illustrating a method 300 for reconfiguring a processor according to an embodiment of the invention. Method 300 may be performed by hardware, firmware, and/or software of a computer system. For purposes of illustration, the description of method 300 may refer to elements of processor 100 and/or system 200; however, method embodiments of the invention are not limited to these illustrative details.

In block 310 of method 300, an event occurs in response to which the processors are to be configured or reconfigured. Such an event may be a transition to or from any power management or other states of system 200.

In block 320 of method 300, BIOS or other system level code selects a thread in the legacy processor (e.g., processor 210) to serve as a system bootstrap processor (SBSP) for the reconfiguration process. In block 322, the BIOS puts all threads in the system, except the SBSP thread, into a state in which they do not execute instructions or generate bus or interconnect transactions or messages, for example, a wait-for-startup-inter-processor-interrupt (Wait-For-SIPI) state. In block 324, the BIOS, running on the SBSP thread, determines a desired configuration for each of the processors to be reconfigured, including desired settings for each configuration register (e.g., configuration storage 120) in each processor. For example, the BIOS may use an algorithm to calculate or attempt to calculate optimum settings for the system. In block 326, the BIOS, running on the SBSP thread, may load the settings into the shadow configuration registers (e.g., shadow configuration storage 130) in each processor. In block 328, the BIOS, running on the SBSP thread, sends a first message (e.g., through a BIOS2Pcode mailbox command) to the pCode in the legacy processor and places the legacy processor in a halt state.

In block 330, in response to the first message, pCode running on the legacy processor, causes the legacy processor to send a second message to the legacy PCH (e.g., PCH 230) to request a multi-socket (i.e., multi-processor) configuration update. The second message may be sent through a sideband link (e.g., third interconnect 270). In block 332, in response to the second message, the legacy PCH sends a third message to a non-legacy PCH (e.g., PCH 240) to request a socket (i.e., processor) configuration update. In block 334, the legacy PCH sends a fourth message to each processor to which it is connected through the sideband link (e.g., processors 210, 212, 214, and 216), and, in response to the third message, the non-legacy PCH sends the fourth message to each processor to which it is connected over the sideband link (e.g., processors 220, 222, 224, and 226), each fourth message to request a socket configuration update.

In block 340, in response to the fourth message, pCode running on each processor confirms that the processor is halted and sets a trigger (e.g., trigger bit 134) in each processor that causes shadow configuration settings (e.g., from shadow configuration storage 130) to be loaded and/or copied into the configuration registers (e.g., configuration storage 120). In block 342, each processor sends a fifth message to the PCH to which it is connected through the sideband link, each fifth message to acknowledge completion of the configuration request (e.g., that the updated configuration settings have been loaded into the configuration registers). In block 344, the non-legacy PCH, in response to receiving the fifth message from each processor to which it is connected through the sideband link, sends a sixth message to the legacy PCH through the sideband link to acknowledge completion the configuration request. In block 346, in response to receiving the fifth message from each processor to which it is connected through the sideband link (except, in an embodiment, the legacy processor) and sixth message from the non-legacy PCH, the legacy PCH sends a seventh message to the legacy processor through the sideband link to acknowledge completion of the configuration request.

In block 350, in response to the seventh message, pCode running on the legacy processor sends an eighth message (e.g., through a Direct2Core(PCU_TRIGGERED) command with special mailbox encoding, as described below) to microcode on the processor core including the SBSP thread (the SBSP microcode). In block 352, in response to the eighth message, the SBSP microcode executes a trap handler to restart the BIOS on the SBSP thread. The trap handler, in response to the special mailbox encoding, increments an instruction pointer to cause BIOS to restart at an instruction after the halt instruction associated with block 328. In block 354, BIOS continues to run on the SBSP thread (e.g., to continue with system initialization).

Thus, method embodiments of the invention, such as method 300, provide for reconfiguration of processors without a system reset. For example, during blocks 330 to 352, the processors in system 200 are reconfigured while no BIOS in running in the system, there is no traffic in-flight that uses the configuration settings, all processor threads are halted, and no system reset is performed. The actions associated with each of these blocks may occur before I/O devices are enumerated in the system, thus ensuring that none of the processors see any I/O traffic during these blocks.

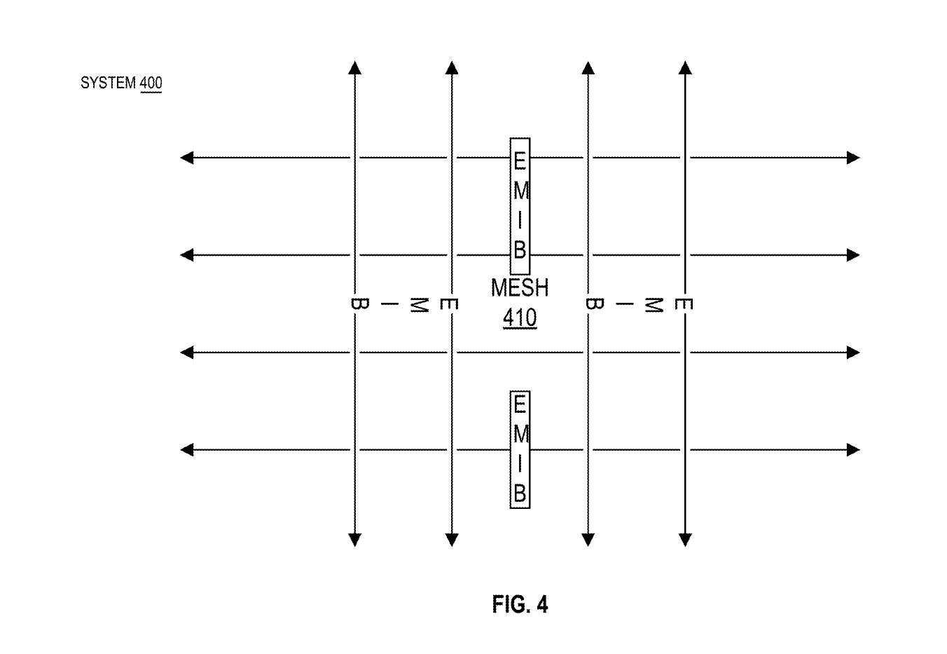

FIG. 4 is a block diagram illustrating a system according to an embodiment of the invention. In FIG. 4, system 400 includes embedded multi-die interconnect bridge (EMID) 410 for mesh connectivity of processors, for example, in a server. In an embodiment, EMIB 410 is a layer (e.g., a PHY layer) to which BIOS based training may be applied to provide for operation at an optimal speed with a low bit error rate, for example, applying different voltage and/or frequency operating conditions to account for process and temperature variations. Before BIOS code fetch starts, EMID 410 may be brought up in a base operating condition. Since the base operating condition is not at the optimal performance point, embodiments of the invention may be used to apply configuration settings while mesh traffic is quiesced before the training. For example, BIOS may reconfigures the EMIBs with a new set of parameters based on system characteristics and indicate to Pcode (through mailbox) to trigger retraining, all without a system reset.

FIG. 5 is a block diagram illustrating a system according to an embodiment of the invention. In FIG. 5, system 500 includes mesh 510 to which one or more accelerators, such as IPx 520 and IPy 530, may be connected, for example through a coherent (MESH-2-IDI) gasket 522 or a non-coherent (MESH-2-IOSF) gasket 532. These accelerators may be dynamically enabled and disabled based on system workloads, for example in cloud computing environments. Embodiments of the invention may provide for dynamic redistribution of credits based on workloads. For example, if IPx 520 or IPy 520 is disabled, then the optimal configuration may be to not allocate any credits to account for IPx or IPy and reuse those credits for accelerators, other IP blocks, or cores that are operational, this potentially achieving higher bandwidth and performance. In this embodiment, accelerators may be kept in a software visible quiesced state during the credit redistribution.

### Exemplary Core Architectures, Processors, and Computer Architectures

The figures below detail exemplary architectures and systems to implement embodiments of the above.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

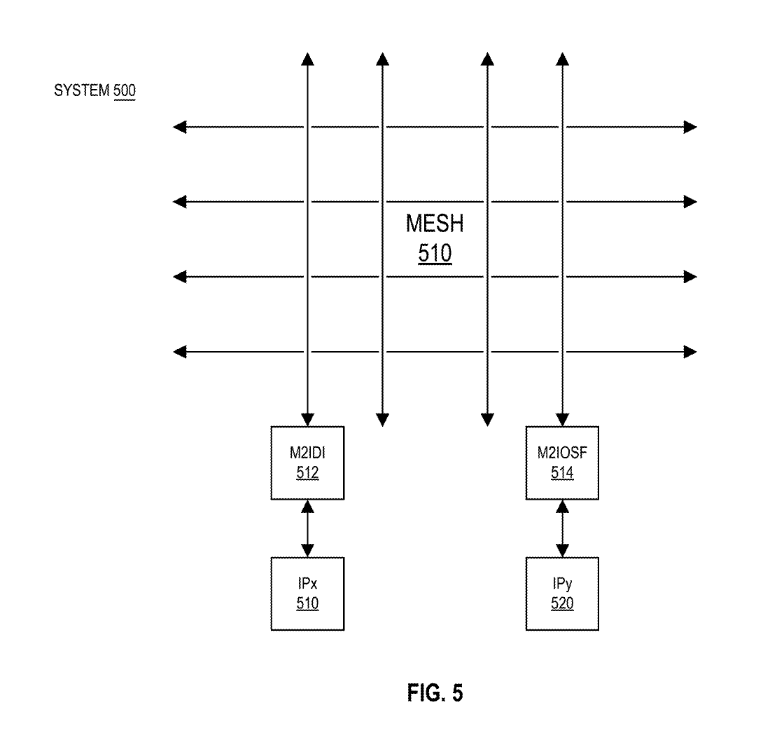

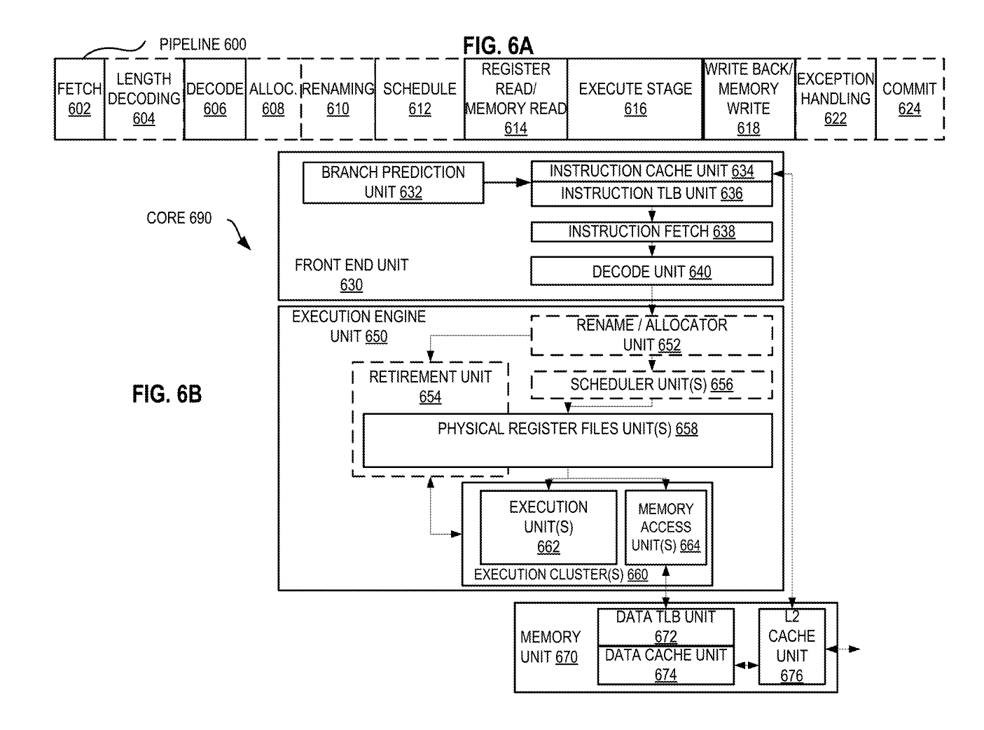

FIG. 6A is a block diagram illustrating both an exemplary in-order pipeline and an exemplary register renaming, out-of-order issue/execution pipeline according to embodiments of the invention. FIG. 6B is a block diagram illustrating both an exemplary embodiment of an in-order architecture core and an exemplary register renaming, out-of-order issue/execution architecture core to be included in a processor according to embodiments of the invention. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632, which is coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a write mask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 7) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 634/674 and a shared L2 cache unit 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

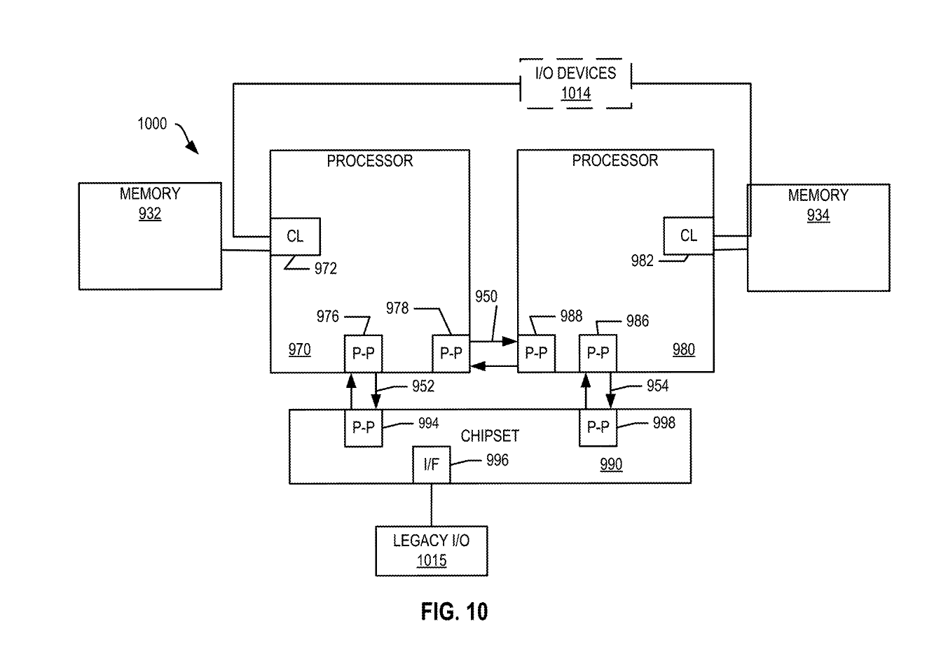

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008 (integrated graphics logic 1008 is an example of and is also referred to herein as special purpose logic), the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

### Exemplary Computer Architectures

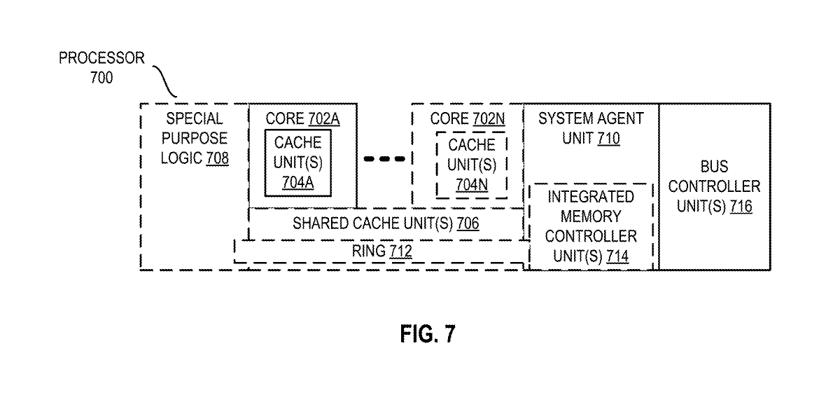

FIGS. 5-8 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

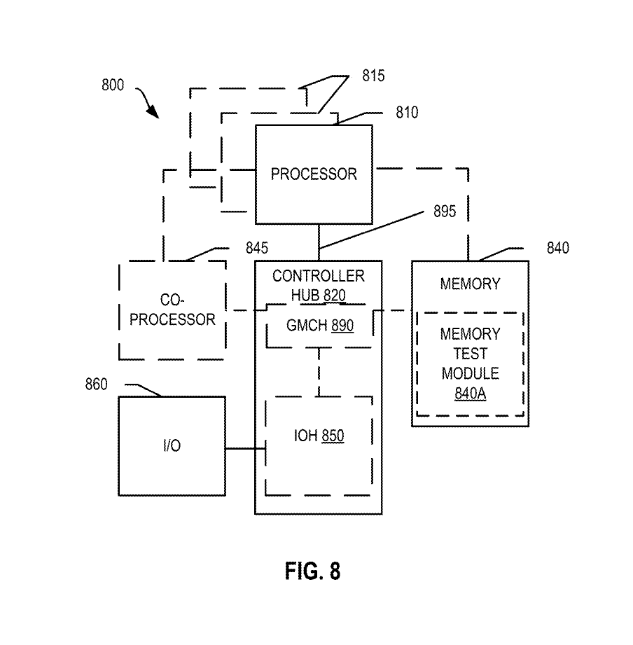

Referring now to FIG. 8, shown is a block diagram of a system 800 in accordance with one embodiment of the present invention. The system 800 may include one or more processors 810, 815, which are coupled to a controller hub 820. In one embodiment, the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 couples input/output (I/O) devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850.

The optional nature of additional processors 815 is denoted in FIG. 8 with broken lines. Each processor 810, 815 may include one or more of the processing cores described herein and may be some version of the processor 1000.

The memory 840 may be, for example, dynamic random access memory (DRAM), phase change memory (PCM), or a combination of the two. For at least one embodiment, the controller hub 820 communicates with the processor(s) 810, 815 via a multi-drop bus, such as a frontside bus (FSB), point-to-point interface such as QuickPath Interconnect (QPI), or similar connection 895.

In one embodiment, the coprocessor 845 is a special-purpose processor, such as, for example, a high-throughput MIC processor, a network or communication processor, compression engine, graphics processor, GPGPU, embedded processor, or the like. In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

Referring now to FIG. 6, shown is a block diagram of a first more specific exemplary system 600 in accordance with an embodiment of the present invention. As shown in FIG. 6, multiprocessor system 600 is a point-to-point interconnect system, and includes a first processor 670 and a second processor 680 coupled via a point-to-point interconnect 650. Each of processors 670 and 680 may be some version of the processor 1000. In one embodiment of the invention, processors 670 and 680 are respectively processors 810 and 815, while coprocessor 638 is coprocessor 845. In another embodiment, processors 670 and 680 are respectively processor 810 coprocessor 845.

Processors 670 and 680 are shown including integrated memory controller (IMC) units 672 and 682, respectively. Processor 670 also includes as part of its bus controller units point-to-point (P-P) interfaces 676 and 678; similarly, second processor 680 includes P-P interfaces 686 and 688. Processors 670, 680 may exchange information via a point-to-point (P-P) interface 650 using P-P interface circuits 678, 688. As shown in FIG. 6, IMCs 672 and 682 couple the processors to respective memories, namely a memory 632 and a memory 634, which may be portions of main memory locally attached to the respective processors.

Processors 670, 680 may each exchange information with a chipset 690 via individual P-P interfaces 652, 654 using point to point interface circuits 676, 694, 686, 698. Chipset 690 may optionally exchange information with the coprocessor 638 via a high-performance interface 692. In one embodiment, the coprocessor 638 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

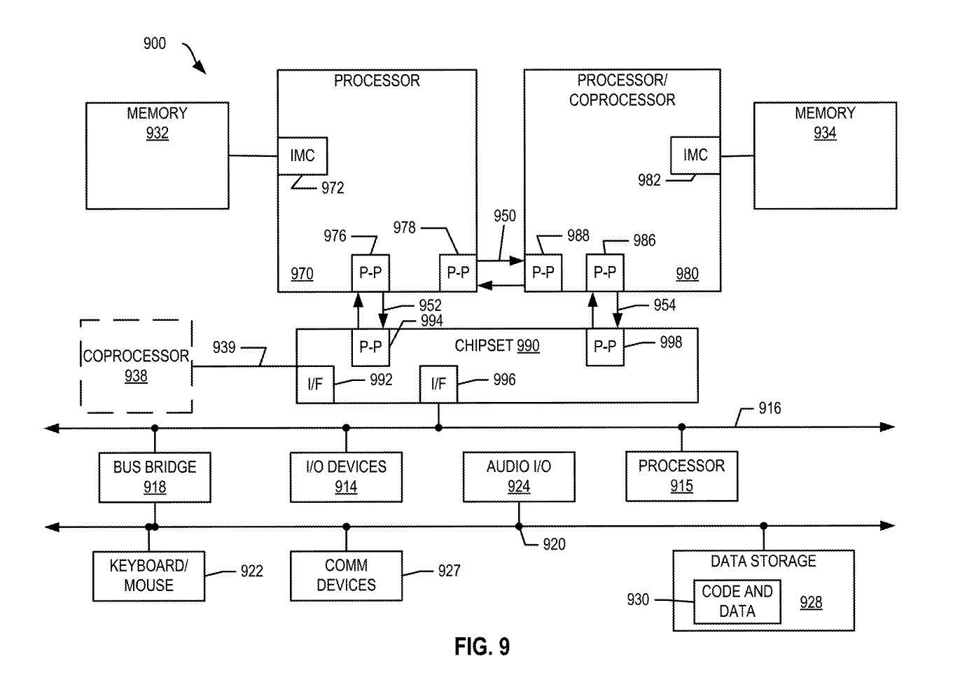

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

Referring now to FIG. 10, shown is a block diagram of a second more specific exemplary system 1000 in accordance with an embodiment of the present invention. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 972 and 982, respectively. Thus, the CL 972, 982 include integrated memory controller units and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

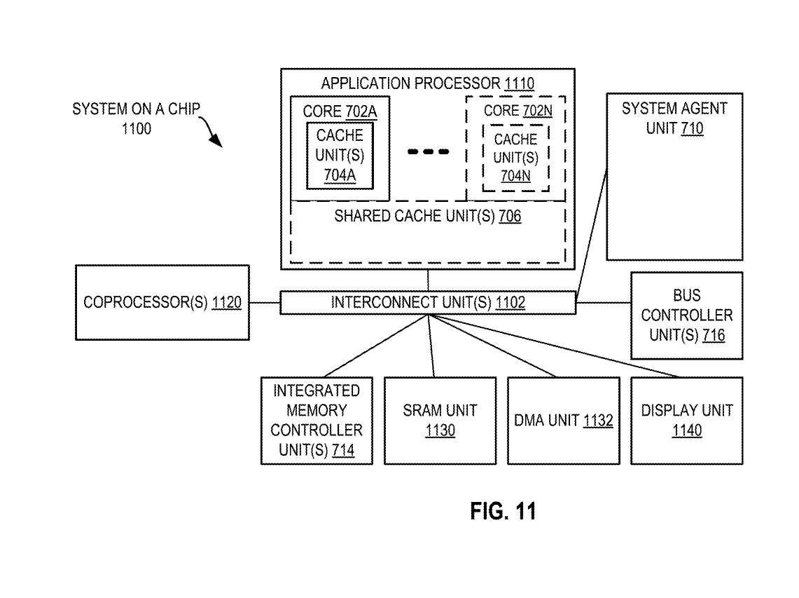

Referring now to FIG. 11, shown is a block diagram of a SoC 1100 in accordance with an embodiment of the present invention. Similar elements in FIG. 10 bear like reference numerals. Also, dashed lined boxes are optional features on more advanced SoCs. In FIG. 11, an interconnect unit(s) 1102 is coupled to: an application processor 1110 which includes a set of one or more cores 1002A-N, which include cache units 1004A-N, and shared cache unit(s) 1006; a system agent unit 1010; a bus controller unit(s) 1016; an integrated memory controller unit(s) 1014; a set or one or more coprocessors 1120 which may include integrated graphics logic, an image processor, an audio processor, and a video processor; an static random access memory (SRAM) unit 1130; a direct memory access (DMA) unit 1132; and a display unit 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In an embodiment, a processor includes configuration storage, shadow configuration storage, trigger storage, and a trigger circuit. The trigger circuit is to cause, based on trigger storage content, shadow configuration storage content to be copied to the configuration storage.

In an embodiment, a method may include loading first configuration settings into first shadow configuration storage in a first processor; setting a first trigger in the first processor to cause the first configuration settings to be copied from the first shadow configuration to first configuration storage in the first processor; and based on the first trigger, copying the first configuration settings from the first shadow configuration to the first configuration storage. Loading the first configuration settings into the first shadow configuration storage is performed by a BIOS. The method may also include selecting, by the BIOS, a thread in the first processor to serve as a SBSP. The method may also include causing, by the BIOS, one or more other threads to enter a wait state. The method may also include sending, by the BIOS, a first message to first firmware on the first processor; and causing, by the BIOS, the first processor to enter a halt state. The method may also include causing, by the first firmware in response to the first message, the first processor to send a second message to a first PCH through a sideband link to request a configuration update. The method may also include sending, by the first PCH in response to the second message, a third message to a second PCH through the sideband link to request the configuration update. The method may also include sending, by the first PCH in response to the second message, a fourth message to a second processor connected to the first PCH through the sideband link to request the configuration update. The method may also include sending, by the second PCH in response to the third message, the fourth message to a third processor connected to the second PCH through the sideband link to request the configuration update. The method may also include setting, by second firmware on the third processor in response to the fourth message, a second trigger in the third processor to cause second configuration settings to be copied from second shadow configuration storage in the third processor to second configuration storage in the third processor. The method may also include sending, by the third processor in response to the fourth message, a fifth message to the second PCH through the sideband link to acknowledge completion of the configuration request. The method may also include sending, by the second PCH in response to the fifth message, a sixth message to the first PCH through the sideband link to acknowledge completion of the configuration request. The method may also include sending, by the first PCH in response to the sixth message, a seventh message to the first processor through the sideband link to acknowledge completion of the configuration request. The method may also include sending, by the first firmware in response to the seventh message, an eighth message to microcode on the first processor; and executing, by the microcode, a trap handler to restart the BIOS on the SBSP thread. The method may also include incrementing an instruction pointer for the SBSP thread in response to the seventh message.

In an embodiment, an apparatus may include means for performing any of the methods described above. In an embodiment, a machine-readable tangible medium may store instructions, which, when executed by a machine, cause the machine to perform any of the methods described above.

In an embodiment, a system may include a first PCH; and a first processor connected to the PCH through a system interconnect and a sideband link, including firmware to cause the first processor to send a configuration update request to the first PCH through the sideband link while the first processor is in a halt state in which it generates no transactions on the system interconnect; first configuration storage; first shadow configuration storage; first trigger storage; and a first trigger circuit to cause, based on the first trigger storage content, first shadow configuration storage content to be copied to the first configuration storage. The system may also include a second processor connected to the first processor through a processor interconnect, wherein the first processor is to send the configuration update request to the first PCH through the sideband link while the first processor is in the halt state in which it generates no transactions on the processor interconnect. The system may also include a second PCH connected to the first PCH and to the second processor through the sideband link, wherein the first PCH is to forward the configuration update request to the second PCH through the sideband link and the second PCH is to forward the configuration update request to the second processor through the sideband link. The second processor may be to send a configuration update acknowledgement to the second PCH through the sideband link, the second PCH to forward the configuration update acknowledgement to the first PCH through the sideband link, and the first PCH to forward the configuration update acknowledgement to the first processor through the sideband link.

What is claimed is:

1. A processor comprising:
configuration storage;
shadow configuration storage;
trigger storage; and
a trigger circuit to cause, based on trigger storage content, shadow configuration storage content to be copied to the configuration storage.

2. A method comprising:
loading first configuration settings into first shadow configuration storage in a first processor;
setting a first trigger in the first processor to cause the first configuration settings to be copied from the first shadow configuration to first configuration storage in the first processor; and
based on the first trigger, copying the first configuration settings from the first shadow configuration to the first configuration storage.

3. The method of claim 2, wherein loading the first configuration settings into the first shadow configuration storage is performed by a basic input/output system (BIOS).

4. The method of claim 3, further comprising selecting, by the BIOS, a thread in the first processor to serve as a system bootstrap processor (SBSP).

5. The method of claim 4, further comprising causing, by the BIOS, one or more other threads to enter a wait state.

6. The method of claim 5, further comprising:
sending, by the BIOS, a first message to first firmware on the first processor; and
causing, by the BIOS, the first processor to enter a halt state.

7. The method of claim 6, further comprising causing, by the first firmware in response to the first message, the first processor to send a second message to a first platform controller hub (PCH) through a sideband link to request a configuration update.

8. The method of claim 7, further comprising sending, by the first PCH in response to the second message, a third message to a second PCH through the sideband link to request the configuration update.

9. The method of claim 8, further comprising sending, by the first PCH in response to the second message, a fourth message to a second processor connected to the first PCH through the sideband link to request the configuration update.

10. The method of claim 9, further comprising sending, by the second PCH in response to the third message, the fourth message to a third processor connected to the second PCH through the sideband link to request the configuration update.

11. The method of claim 10, further comprising setting, by second firmware on the third processor in response to the fourth message, a second trigger in the third processor to cause second configuration settings to be copied from second shadow configuration storage in the third processor to second configuration storage in the third processor.

12. The method of claim 11, further comprising sending, by the third processor in response to the fourth message, a fifth message to the second PCH through the sideband link to acknowledge completion of the configuration request.

13. The method of claim 12, further comprising sending, by the second PCH in response to the fifth message, a sixth message to the first PCH through the sideband link to acknowledge completion of the configuration request.

14. The method of claim 13, further comprising sending, by the first PCH in response to the sixth message, a seventh message to the first processor through the sideband link to acknowledge completion of the configuration request.

15. The method of claim 14, further comprising:
sending, by the first firmware in response to the seventh message, an eighth message to microcode on the first processor; and
executing, by the microcode, a trap handler to restart the BIOS on the SBSP thread.

16. The method of claim 15, further comprising incrementing an instruction pointer for the SBSP thread in response to the seventh message.

17. A system comprising:
a first platform controller hub (PCH); and
a first processor connected to the PCH through a system interconnect and a sideband link, including:
firmware to cause the first processor to send a configuration update request to the first PCH through the sideband link while the first processor is in a halt state in which it generates no transactions on the system interconnect;
first configuration storage;
first shadow configuration storage;
first trigger storage; and
a first trigger circuit to cause, based on the first trigger storage content, first shadow configuration storage content to be copied to the first configuration storage.

18. The system of claim 17, further comprising a second processor connected to the first processor through a processor interconnect, wherein the first processor is to send the configuration update request to the first PCH through the sideband link while the first processor is in the halt state in which it generates no transactions on the processor interconnect.

19. The system of claim 18, further comprising a second PCH connected to the first PCH and to the second processor through the sideband link, wherein the first PCH is to forward the configuration update request to the second PCH through the sideband link and the second PCH is to forward the configuration update request to the second processor through the sideband link.

20. The system of claim 19, wherein the second processor is to send a configuration update acknowledgement to the second PCH through the sideband link, the second PCH is to forward the configuration update acknowledgement to the first PCH through the sideband link, and the first PCH is to forward the configuration update acknowledgement to the first processor through the sideband link.
